(19) United States
(12) Patent Application Publication
(10) Pub. No.: US 2021/0284042 A1
(43) Pub. Date: Sep. 16, 2021

(54) BATTERY CONTROL SYSTEM AND BATTERY CONTROL PROGRAM

(71) Applicant: HONDA MOTOR CO., LTD., Tokyo (JP)

(72) Inventor: Yoshikazu NISHIDA, Saitama (JP)

(21) Appl. No.: 17/192,902

(22) Filed: Mar. 5, 2021

(30) Foreign Application Priority Data
Mar. 10, 2020 (JP) 2020-040902

(51) Int. Cl. B60L 53/66; B60L 58/12; G07C 5/00; G07C 5/08

(52) U.S. Cl. CPC B60L 53/66; G07C 5/0825; G07C 5/008; B60L 58/12

(57) ABSTRACT

A battery control system and a battery control program are provided which are capable of determining a residual value of a battery according to control contents of the battery and giving a user a return for the residual value.

A battery control system includes: an electric motor vehicle 10 including a battery 40, a communication device 50, a battery control unit 36, and a display device 60; and a server device 300.

This application is based on and claims the benefit of priority from Japanese Patent Application No. 2020-040902, filed on 10 Mar. 2020, the content of which is incorporated herein by reference.

### BACKGROUND OF THE INVENTION

### Field of the Invention

The present invention relates to a battery control system and a battery control program.

### Related Art

Electric motor vehicles that travel by motor driving force, such as electric cars and hybrid cars, have been conventionally provided.

Such electric motor vehicles drive a motor by power from a rechargeable secondary cell (battery).

In a known technique, power stored in a battery can be used for a residential storage battery.

Degradation of a battery progresses with continued use and according to its degradation state, the battery is reused.

Since battery degradation varies according to a use state, battery states are classified based on a battery operating state to expand the application range of reuse in proposed techniques (for example, see Patent Document 1).

Patent Document 1: Japanese Unexamined Patent Application, Publication No. 2017-152333

### SUMMARY OF THE INVENTION

A battery in an electric motor vehicle has a high relative value and therefore, it is preferable for users owning an electric motor vehicle and lease companies that electric vehicles be used so as to leave a residual value of a battery.

In addition, it is considered that giving incentives to a user who has used an electric motor vehicle so as to leave a residual value of a battery allows the user to be given a return for the residual value of the battery.

However, under the present circumstances, a control system for controlling the use of a battery as described above has not been proposed.

The present invention has been made in view of the above, and it is an object of the present invention to provide a battery control system and a battery control program that are capable of determining a residual value of a battery according to control contents of the battery and giving a user a return for the residual value.

(1) The present invention relates to a battery control system that includes: an electric motor vehicle including a battery, a communication device, a battery control unit, and a display device; and a server device. The battery control unit performs charge/discharge control of the battery by restricting part of functions of the battery and removes restrictions on part of functions of the battery on the battery in response to an input of a restriction removal key. The display device displays information on the part of functions of the battery which is restricted by the battery control unit. The server device includes: a reception unit that receives a restriction removal request which is transmitted from the communication device; and a transmission unit that transmits the restriction removal key to the communication device.

According to the invention of (1), the battery control system can be provided which is capable of determining a residual value of the battery according to battery control contents and giving a user a return for the battery residual value.

(2) The battery control system according to (1) in which the part of battery functions which is restricted by the battery control unit includes an allowable traveling distance per unit period of the electric motor vehicle.

According to the invention of (2), the battery control system can be provided which controls the battery functions based on the allowable traveling distance per unit period so as to promote safe driving of the electric motor vehicle, thereby improving the residual value of the battery.

(3) The battery control system according to (1) or (2) in which the electric motor vehicle further includes a power transmission device that transmits power stored in the battery to the outside, the part of battery functions which is restricted by the battery control unit includes the amount of power transmitted to the outside by the power transmission device per unit period.

According to the invention of (3), the battery functions are controlled based on the amount of power transmitted to the outside per unit period and therefore, a residual value of the battery, which is obtained when the battery is used for transmitting power to the outside where less load variation occurs, is determined so as to allow a user to be given a return for it.

(4) The present invention also relates to a battery control program for controlling a battery mounted on an electric motor vehicle. The battery control program causes execution of: a registration step of registering a discharge capacity of the battery for each discharge purpose; an identification step of identifying a discharge purpose at the time of discharge of the battery; an output step of outputting an allowable discharge capacity based on the registered discharge capacity of the battery for the each discharge purpose; and a discharge control step of outputting a discharge control signal when the discharge capacity is insufficient.

According to the invention of (4), a battery control program can be provided which is capable of determining a residual value of the battery according to battery control contents and giving a user a return for the battery residual value.

### BRIEF DESCRIPTION OF THE DRAWINGS

FIG. 1 shows a diagram illustrating a configuration of a battery control system according to an embodiment of the present invention;

FIG. 2 shows graphs showing example of control contents in the battery control system of the present invention; and

FIG. 3 shows a diagram illustrating a flowchart of a battery control program according to the embodiment of the present invention.

### DETAILED DESCRIPTION OF THE INVENTION

### Battery Control System

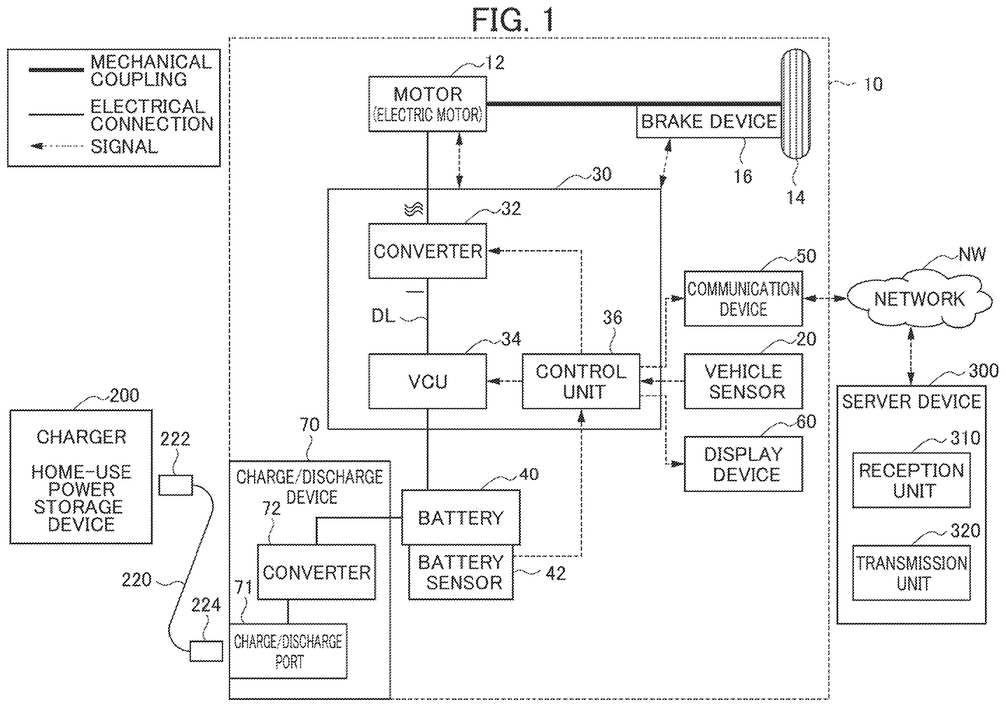

FIG. 1 shows a diagram illustrating a battery control system according to an embodiment of the present invention.

The battery control system according to the present embodiment includes an electric motor vehicle 10 and a server device 300 as illustrated in FIG. 1.

The electric motor vehicle 10 is a vehicle mounted with a secondary cell (battery) 40 that supplies power for traveling, such as an electric car and a hybrid car.

The electric motor vehicle 10 can discharge power charged in the battery 40 to the outside.

For example, the battery 40 is discharged by performing discharge control by a battery control unit 36 while a plug 222 which is provided at one end of an external charging cable 220 is connected to a home-use power storage device 200 and a plug 224 which is provided at another end of this charging cable 220 is connected to a charge/discharge port 71 provided on an exterior of a body of the electric motor vehicle 10.

The discharged power is stored in the home-use power storage device 200.

On the other hand, the battery 40 is charged by performing charge control by a charge control unit (not illustrated) of a charger 200 while the plug 222 is connected to the charger 200.

Instead of connection by the charging cable 220, such a configuration can also be widely used that performs noncontact charging or that performs charging with power of an internal combustion engine, a fuel battery, or the like which is provided in the electric motor vehicle 10.

The electric motor vehicle 10 includes, for example: a motor 12; driving wheels 14; a brake device 16, a vehicle sensor 20, a power control unit (PCU) 30, a battery (secondary cell) 40, a battery sensor 42, a communication device 50, a display device 60, and a charge/discharge device 70 as a power transmission device.

The motor 12 is, for example, a three-phase AC electric motor. The motor 12, which has a rotor coupled to the driving wheels 14, drives the driving wheels 14 by supplied power and at the time of deceleration, outputs power by generating power with rotational energy of the driving wheels 14.

The brake device 16 includes, for example: a brake caliper; a cylinder that transfers hydraulic pressure to the brake caliper; and an electric motor that generates hydraulic pressure in the cylinder. The brake device 16 may include a mechanism as a backup that transfers the hydraulic pressure generated by the operation of a brake pedal to the cylinder via a master cylinder.

The brake device 16 is not limited to the configuration described above and may be an electronically controlled hydraulic brake device that transfers the hydraulic pressure of the master cylinder to the cylinder.

The vehicle sensor 20 includes an accelerator opening sensor, a vehicle speed sensor, and a brake depression amount sensor.

The accelerator opening sensor, which is attached to an accelerator pedal that is one example of an operator that receives an acceleration instruction by a driver, detects the operation amount of the accelerator pedal and outputs it to the battery control unit 36 as an accelerator opening.

The vehicle speed sensor, which includes, for example, a wheel speed sensor attached to each wheel and a speed calculator, integrates wheel speeds which are detected by a plurality of the wheel speed sensors, thereby deriving the speed of the vehicle (vehicle speed) and outputting it to the battery control unit 36 and the display device 60.

The brake depression amount sensor, which is attached to a brake pedal, detects the operation amount of the brake pedal and outputs it as a brake depression amount to the battery control unit 36.

The PCU 30 includes, for example, a converter 32, a voltage control unit (VCU) 34, and a battery control unit 36.

These components may be dispersedly arranged without being integrated as the PCU 30.

The converter 32 is, for example, an AC-DC converter.

A DC terminal of the converter 32 is connected to a DC link DL.

The DC link DL is connected to the battery 40 via the VCU 34.

In deceleration, the converter 32 converts AC power which is generated by the motor 12 into DC power and outputs it to the DC link DL.

Conversely, in driving the motor 12, the converter 32 converts DC power which is output from the VCU 34 into AC power via the DC link DL and outputs it to the motor 12.

The VCU 34 is, for example, a DC-DC converter.

In driving the motor 12, the VCU 34 boosts power which is supplied from the battery 40 and outputs it to the DC link DL; and conversely, in deceleration, it outputs power which is output from the DC link DL, at a predetermined voltage to the battery 40.

The battery control unit 36 controls the battery 40 and the VCU 34.

The PCU 30 further includes as control units a motor control unit and a brake control unit.

The battery control unit, the motor control unit, and the brake control unit may be replaced with separate control devices, for example, a battery ECU, a motor ECU, and a brake ECU, respectively.

The battery control unit 36 calculates a state of charge (SOC: battery charging rate) of the battery 40 based on an output of a battery sensor 42 which is attached to the battery 40; and outputs it to the VCU 34.

The VCU 34 boosts voltage of the DC link DL in response to an instruction from the battery control unit 36.

The VCU 34 transmits power to the home-use power storage device 200 which is externally provided, in response to an instruction from the battery control unit 36.

A storage unit included in the battery control unit 36 stores a battery control program described later and the battery control unit 36 performs control to restrict part of functions of the battery 40 and remove restrictions thereon.

The motor control unit controls the motor 12 based on an output of the vehicle sensor 20.

The brake control unit controls the brake device 16 based on an output of the vehicle sensor 20.

The battery 40 is, for example, a secondary cell such as a lithium ion battery.

The battery 40 stores power supplied from the charger 200 which is provided outside the electric motor vehicle 10; and discharges the stored power for traveling of the electric motor vehicle 10 or for storage of the home-use power storage device 200.

In addition, in deceleration, the battery stores power which is output from the VCU 34.

The battery sensor 42 includes, for example, a current sensor, a voltage sensor, and a temperature sensor.

The battery sensor 42 detects, for example, a current value, voltage value, and temperature of the battery 40.

The battery sensor 42 outputs the detected current value, voltage value, temperature, and the like to the battery control unit 36.

The communication device 50 includes a wireless module for connecting a cellular network or a Wi-Fi network.

The communication device 50 is intercommunicable with the server device 300 via a network NW illustrated in FIG. 1.

A user of the electric motor vehicle 10 (hereinafter, may be simply described as “user”) can transmit a restriction removal request, for requesting to remove restrictions on part of functions of the battery 40 which has been restricted by the battery control unit 36, to the server device 300 via the communication device 50.

The display device 60 includes, for example, a display unit and a display control unit.

The display unit displays information according to control of the display control unit.

The display control unit controls the display unit to display information on the battery 40 according to information which is output from the vehicle sensor 20 and the battery control unit 36.

For example, it performs control to display information on part of functions of the battery 40 which is restricted by the battery control unit 36.

The display control unit controls the display unit to display vehicle speed and the like which are output from the vehicle sensor 20.

The charge/discharge device 70 as a power transmission device includes a charge/discharge port 71 and a converter 72.

The charge/discharge device 70 converts AC power which is derived from the charger 200 via the charge/discharge port 71 into DC power and charges the battery 40 with it.

In addition, the charge/discharge device 70 transmits DC power which is discharged from the battery 40, to the external home-use power storage device 200.

Transmission of power of the battery 40 to the external home-use power storage device 200 is identified by, for example, detecting the state of the plug 224 being connected to the charge/discharge port 71.

The server device 300, which is intercommunicable with the communication device 50, includes a reception unit 310 and a transmission unit 320.

One or all of those components may be also implemented by hardware (including circuitry) such as a large scale integration (LSI), an application specific integrated circuit (ASIC), a field-programmable gate array (FPGA), or a graphics processing unit (GPU), or may be implemented in cooperation between software and hardware.

The reception unit 310 receives a restriction removal request which is transmitted from the communication device 50.

The restriction removal request includes user identification information and restriction removal contents.

The received restriction removal request is stored in the server device 300 and a restriction removal key is output.

At the same time of outputting of the restriction removal key, a billing amount may be calculated according to the restriction removal contents and may be stored in the server device 300 together with the user identification information.

An administrator of: the server device 300 (for example, a leasing company of the electric motor vehicle 10) can bill the user based on the user identification information and billing amount.

The transmission unit 320 transmits the above output restriction removal key to the communication device 50.

The restriction removal key received by the user via the communication device 50 is input to the battery control unit 36.

In response to input of the restriction removal key, the battery control unit 36 removes restrictions on part of functions of the battery 40 according to the restriction removal contents.

### Battery Control Unit

The following describes the details of the configuration of the battery control unit 36.

The battery control unit 36 performs charge/discharge control of the battery 40 by restricting part of functions of the battery 40 in accordance with a contract of the user, or the like.

For example, when purchasing or starting leasing the electric motor vehicle 10, a user concludes a contract related to an available discharge capacity of the battery 40 per unit period for each application of the battery 40, together with a purchase contract or a lease contract.

Here, the unit period can be freely set; for example, it can be one day, one week, or one month.

In addition, example applications of the battery 40 include traveling of the electric motor vehicle 10 and power transmission to the external home-use power storage device 200.

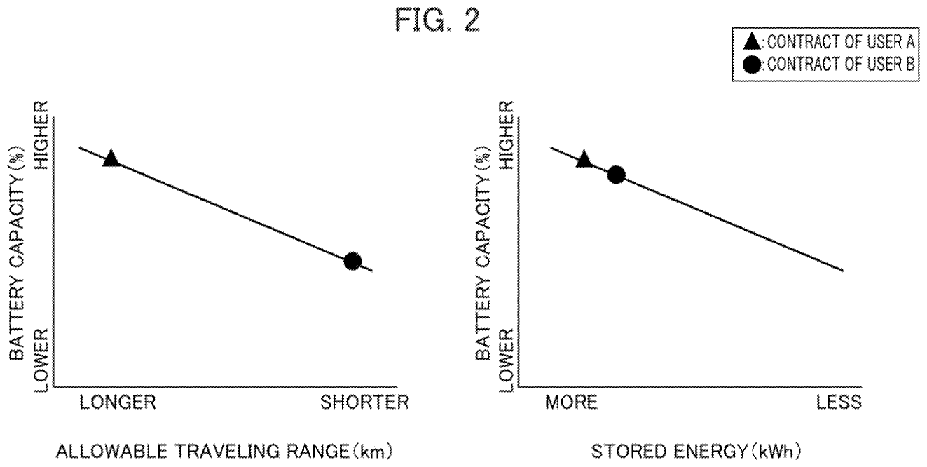

FIG. 2 is graphs schematically showing the contract contents of users of the electric motor vehicle 10.

A vertical axis in each of the graphs in FIG. 2 represents a battery capacity (%) per unit period, which is represented, for example, by the state of charge (SOC: battery charging rate).

Horizontal axes in the graphs in FIG. 2 correspond to, for example, an allowable traveling range (km) per unit period of the electric motor vehicle 10 and a stored energy (kwh) for the home-use power storage device 200.

It is considered that regulating the application of the battery 40 for traveling of the electric motor vehicle 10 by a distance not electric energy, can prevent driving at excessive speed and reckless driving which can accelerate degradation of the battery 40.

As shown in FIG. 2, in a contract of a user A, a long allowable traveling range and much stored energy are set.

On the other hand, in a contract of a user B, a short allowable traveling range and much stored energy are set.

In the contract of the user B, the allowable traveling range per unit period is shorter than that for the user A.

Therefore, when the battery 40 is controlled in accordance with the contract of the user B, a load on the battery 40 is considered to be reduced in comparison with control in accordance with the contract of the user A; and thus, a residual value of the battery 40 after a period of the contract has passed is expected to be higher.

According to the above, for example, in leasing the electric motor vehicle 10, a leasing company can give incentives to the user B rather than the user A in consideration of contract contents.

The user B can obtain incentives by concluding a contract according to an application of the battery 40, thereby, for example, being able to be provided with the electric motor vehicle 10 inexpensively.

Beside the above, according to estimated degradation of the battery 40, incentives given to the user may be differentiated.

For example, even in cases where the battery capacity per unit period is the same, when the battery 40 is used for power transmission to the home-use power storage device 200, a degradation degree of the battery 40 is considered to be smaller than when the battery is used for traveling of the electric motor vehicle 10.

This is because it is considered that when the battery 40 is used for power transmission to the home-use power storage device 200, an abrupt load variation, which occurs when the battery is used for traveling of the electric motor vehicle 10, occurs less and therefore, the progress of degradation of the battery 40 can be prevented.

The battery control unit 36 can remove restrictions on part of functions of the battery 40 in response to a user's desire.

For example, assume that a user has concluded a contract that specifies that under a normal condition, the travelling distance of the electric motor vehicle 10 is short and an allowable traveling range is short.

The user may desire to increase the allowable travelling range of the electric motor vehicle 10 only for a specified period, for example. In this case, the user obtains a restriction removal key via the communication device 50 and inputs it in the battery control unit 36. This allows the battery control unit 36 to remove, for example, a restriction on the allowable traveling range of the electric motor vehicle 10, which is a part of the restricted functions of the battery 40.

The removal of restrictions described above may be performed for all the restrictions of the functions of the battery 40 or may be performed for part of them.

### Battery Control System

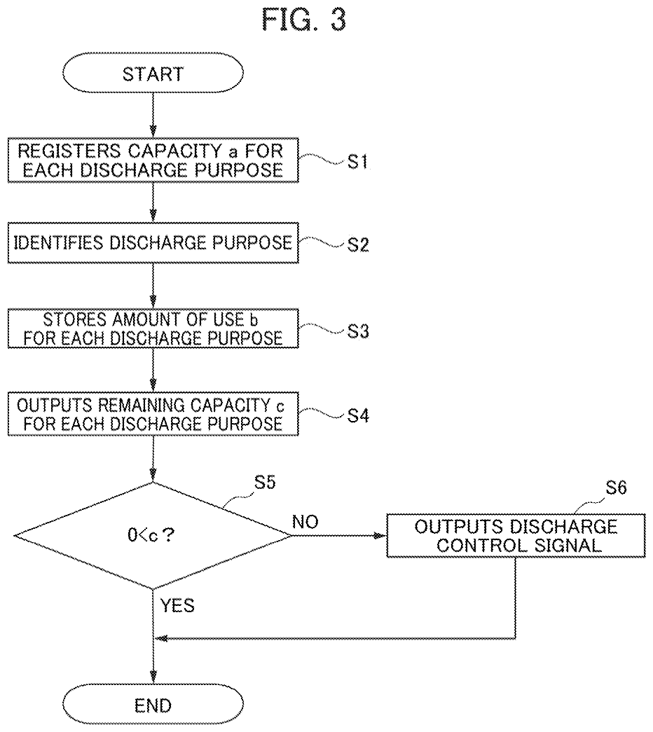

A procedure performed by a battery control program according to the present embodiment will be described with reference to FIG. 3.

The battery control program according to the present embodiment is stored and retained in the storage unit of the battery control unit 36 of the electric motor vehicle 10.

The battery control program according to the present embodiment, causes execution of: a registration step S1; an identification step S2; a storage step S3; an output step S4; a determination step S5; and a discharge control signal output step S6.

According to the battery control program, at the registration step S1, discharge purposes (for example, traveling of the electric motor vehicle 10) and a capacity for each of the discharge purposes (for example, an allowable traveling range a) based on the user contract are stored for registration in the storage unit of the battery control unit 36 in advance.

According to the battery control program, at the identification step S2, a battery discharge purpose is identified based on a detection result corresponding to the battery discharge purpose. For example, based on a detection result that the battery 40 is discharging and the plug 224 is connected to the charge/discharge port 71, the discharge purpose of the battery 40 is identified as power transmission to the outside (for example, the home-use storage device 200).

Likewise, based on a detection result that the battery 40 is discharging and the plug 224 is not connected to the charge/discharge port 71, the discharge purpose of the battery 40 is identified as traveling of the electric motor vehicle 10.

According to the battery control program, at the discharge amount storage step S3, an integrated amount of usage of the battery 40 per unit period is stored for each discharge purpose identified at the identification step S2.

For example, an integrated traveling distance b(km) of the electric motor vehicle 10 for each day is stored based on information received from the vehicle sensor 20.

According to the battery control program, at the output step S4, a remaining capacity for each discharge purpose is output.

For example, when traveling of the electric motor vehicle 10 is a discharge purpose, for which an allowable traveling range a of 100 km for each day is registered, and an integrated traveling distance b for a current day is 30 km, a difference between the above distances (a-b) is calculated, thereby outputting 70 km (c) as a remaining capacity.

According to the battery control program, at the determination step S5, whether there is a remaining capacity for each discharge purpose is determined.

More specifically, it is determined that a remaining capacity for each discharge purpose, which is output at the output step S4, is a positive value.

If YES for the above, processing ends.

If NO for the above, the processing proceeds to the discharge control signal output step S6.

According to the battery control program, at the discharge control signal output step S6, a discharge control signal for controlling the amount of discharge from the battery is output. The discharge control signal, for example, may cause the battery control device 36 to perform control to stop or reduce the discharge of the battery; or may cause the display device 60 to display an alarm.

After the discharge control signal output step S6 is performed, processing ends.

Although a preferred embodiment according to the present invention has been described above, the present invention is not limited to the above embodiment and appropriate modifications are also within the scope of the present invention.

### EXPLANATION OF REFERENCE NUMERALS

10 electric motor vehicle

36 battery control unit

40 battery

50 communication device

60 display device

70 charge/discharge device (power transmission device)

300 server device

310 reception unit

320 transmission unit

What is claimed is:

1. A battery control system, comprising:
an electric motor vehicle including a battery, a communication device, a battery control unit, and a display device; and
a server device,
wherein
the battery control unit performs charge/discharge control of the battery by restricting part of functions of the battery and removes restrictions on part of functions of the battery in response to an input of a restriction removal key;
the display device displays information on the part of functions of the battery, the part being restricted by the battery control unit; and
the server device includes:
a reception unit receiving a restriction removal request, the restriction removal request being transmitted from the communication device; and
a transmission unit transmitting the restriction removal key to the communication device.

2. The battery control system according to claim 1, wherein
the part of functions of the battery, the part being restricted by the battery control unit, includes an allowable traveling distance per unit period of the electric motor vehicle.

3. The battery control system according to claim 1, wherein
the electric motor vehicle further includes a power transmission device transmitting power to an outside, the power having been stored in the battery; and
the part of functions of the battery, the part being restricted by the battery control unit, includes an amount of power transmitted per unit period by the power transmission device to the outside.

4. A battery control program controlling a battery mounted on an electric motor vehicle, the battery control program causing execution of:
a registration step of registering a discharge capacity of the battery for each discharge purpose;
an identification step of identifying a discharge purpose of the battery in discharging;
an output step of outputting an allowable discharge capacity based on the registered discharge capacity of the battery for the each discharge purpose; and
a discharge control step of outputting, when the discharge capacity is insufficient, a discharge control signal.
